(19) United States
(12) Patent Application Publication
(10) Pub. No.: US 2013/0124890 A1
(43) Pub. Date: May 16, 2013

(54) MULTI-CORE PROCESSOR AND METHOD OF POWER MANAGEMENT OF A MULTI-CORE PROCESSOR

(71) Applicants: Michael Priel, Hertzelia (IL); Anton Rozen, Gedera (IL); Yossi Shoshany, Gan Yavne (IL)

(72) Inventors: Michael Priel, Hertzelia (IL); Anton Rozen, Gedera (IL); Yossi Shoshany, Gan Yavne (IL)

(21) Appl. No.: 13/811,942

(22) PCT Filed: Jul. 27, 2010
(86) PCT No.: PCT/IB10/53409

§ 371 Date: Jan. 24, 2013

(51) Int. Cl. G06F 1/32

(52) U.S. Cl. CPC G06F 1/3234
USPC 713/320

(57) ABSTRACT

A multi-core processor includes a plurality of power gating elements for controlling power applied to each core. Each power gating element is coupled to a respective power gating controllers for controlling the respective power gating element to selectively provide full power to the respective core only during an active period of the respective core. A common power gating controller is coupled to the individual power gating controllers for controlling the individual power gating controllers to balance the active periods of the plurality of cores so as to substantially reduce or minimise overlapping active periods so as to reduce the total power provided to all the cores.

### FIELD OF THE INVENTION

This invention relates to a multi-core processor and a method of power management of a multi-core processor.

### BACKGROUND OF THE INVENTION

Multi-core processors, that is, processors having a plurality of processing cores are well known and are often used in mobile and other applications where high performance (at least some of the time) and low power consumption are critical. It is known that performance can be increased by increasing the voltage, increasing the operating frequency, or increasing both, of either the whole device or individual cores on the device. Conversely, reducing the power supply voltage level to save power can be done for the whole device, but for multi-core devices, this would mean a drop in the voltage for all the cores. If the cores are running with different power requirements, then varying the voltage supply for the device may not be acceptable. Therefore, power gating is often used to control the voltage supply to individual cores using power gates.

Power gating involves inserting a gate (such as a transistor) between the power supply and the core. By turning the gate off, the power to the core can be effectively removed. This is termed Per Core Power Gating (PCPG). However, if the power to the core is completely shut off, then some devices in the core, may lose data or, at least, a “memory” of their state prior to power shut-off. Therefore, a technique known as State Retention Power Gating (SRPG) has been developed whereby the power gate includes a memory device for retaining knowledge of the states of the devices on the core prior to shutting-off the power, and for enabling those states when the power is switched back on.

As the power used by the core increases, and as the frequency of operation increases, leakage power, that is the power that is lost from the core, for example by heat, is increased relative to the dynamic power used by the core for processing. Indeed, as the temperature increases, the proportion of leakage power compared to the dynamic power increases still further.

Thus, it has been necessary to use all possible techniques to try to reduce the power used by a device, including power reduction, frequency reduction and power gating, such as SRPG. Nevertheless, all these techniques rely on monitoring the power requirements of individual cores and using the various power management techniques based on the power requirements of that core, independently of the power requirements of the other cores in the device. In some cases, the cores may be controlled to have one of several different power modes, including full power, no power, and one or more degrees of intermediate power depending on the application of the processor, such as, for example, sleep mode.

### SUMMARY OF THE INVENTION

The present invention provides a multi-core processor and a method of power management of a multi-core processor as described in the accompanying claims.

Specific embodiments of the invention are set forth in the dependent claims.

These and other aspects of the invention will be apparent from and elucidated with reference to the embodiments described hereinafter.

### BRIEF DESCRIPTION OF THE DRAWINGS

Further details, aspects and embodiments of the invention will be described, by way of example only, with reference to the drawings. In the drawings, like reference numbers are used to identify like or functionally similar elements. Elements in the figures are illustrated for simplicity and clarity and have not necessarily been drawn to scale.

FIG. 1 schematically shows an example of an embodiment of a multi-core processor;

FIG. 2 schematically shows a diagram of active periods of two cores running on the processor, in both a very active condition and a moderately active condition; and

FIG. 3 schematically shows a diagram of leakage and dynamic power for active periods of two cores of the processor.

### DETAILED DESCRIPTION OF THE PREFERRED EMBODIMENTS

Because the illustrated embodiments of the present invention may for the most part, be implemented using electronic components and circuits known to those skilled in the art, details will not be explained in any greater extent than that considered necessary, for the understanding and appreciation of the underlying concepts of the present invention and in order not to obfuscate or distract from the teachings of the present invention.

In general, a multi-core processor is an integrated circuit having two or more processing cores coupled via one or more buses to an interface. Each of the cores may have a memory cache associated therewith, and the integrated circuit may also have a further memory cache(s) provided thereon which may be shared by some or all the cores. As will be appreciated by a person skilled in the art, other functional units may also be provided on the integrated circuit, for use by one or more of the cores. Although the multiple cores are usually integrated onto a single die, in some cases, the cores may be on multiple dies, all combined into a single chip package.

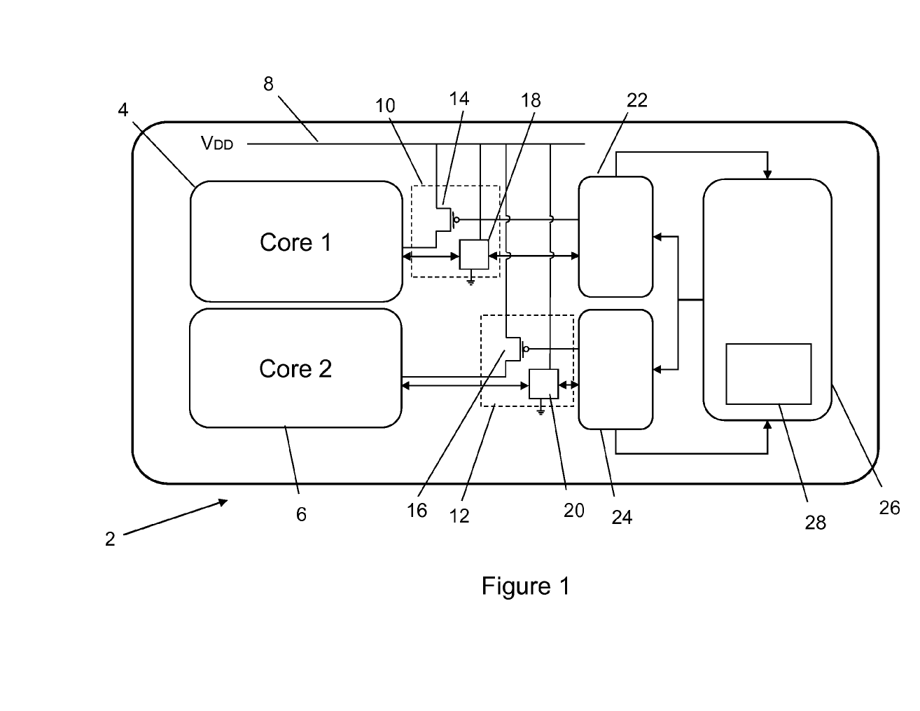

Referring to FIG. 1, a multi-core processor 2 includes two or more processing cores 4, 6, each of which may be active or not. Each core may execute different instructions, e.g. run a different software program, than the other core or cores. For example, in the case of application in a mobile device, a core may be running the communications between the mobile device and a base station, while another core may be running a game or other application that the user chooses. Some or all the cores may not be active all the time. For example, particularly if the mobile device is not moving between cells, the communication software may only need to communicate with the base station periodically to maintain a connection with the base station, even if no actual call, data or voice, is in operation. Thus, the core running the communication software can be powered down, for example into a sleep mode, between such times when it needs to communicate with the base station. Similarly, if a core is running a user interactive program that depends, for example, on constant user input, then this core also may be powered down between user inputs, if no other processing is required, because user input, even if “constant” from the point of view of the user, actually allows the core to be put into sleep mode between user input key strokes.

Each of the shown cores 4, 6 is connected to a power supply line 8 via a power gating element 10, 12. However, it will be apparent that additional cores may be present that are not power gated, which are, for example, directly connected to the power supply 8 without a power gating element between them. The power gating element generally comprises a power gate, such as a transistor 14, 16, but may also include a memory device, such as a latch 18, 20 for storing the states of devices in the particular core, and may include other components that may be used for retaining states and enabling the devices when power is restored. If the core can be put into three different power modes, for example, full power, no power or “sleep” mode, then other components in the power gate element may be used for controlling which mode the core is put into and which parts of the core are powered and which are not, in the case of, for example, the sleep mode.

Each power gating element 10, 12 is coupled to an individual gate controller 22, 24, which is used to control the respective power gating element to switch the power mode of the respective core to the required mode. The gate controllers 22, 24 are coupled to a common gating controller 26, which controls the individual gate controllers to control the power gating elements to balance the overall load across the cores of the processor. Thus, the common gating controller 26 receives inputs indicating the processing needs of each core and tries to balance them across all the cores to minimise overlaps in active periods. The plurality of inputs may be coupled to the plurality of individual power gating controllers for receiving indications from the plurality of individual power gating controllers regarding the active periods of the respective cores. The common power gating controller may also have one or more inputs for receiving indications of the different programs running on each core so as to be able to balance the active periods of the plurality of cores based on a predetermined knowledge of the likely required active periods for the different programs. The common gating controller 26 includes a memory 28 that can store information about the processing needs, and hence active periods and power needs of different software programs that any of the cores might run. The common gating controller 26 may also store historical data on the history of the user and how the processor is used, so as to predict the likely requirements of activity and power. This enables the active periods of the cores to be balanced with more accuracy and with fewer cores being active at the same time.

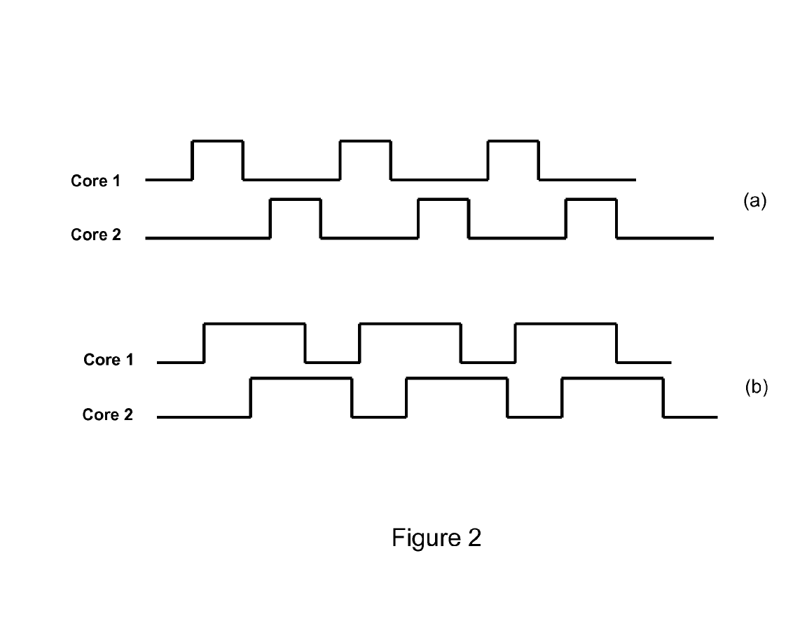

If, as in this embodiment, there are two cores, each of which runs a program that is only active for an average of less than 50% of the time, then, as shown in FIG. 2 (a), it is possible to balance the active periods of the two cores in such a way that they do not overlap by delaying the active period of one or other the cores according to their needs. This means that the power being used at any one time is at a minimum and the temperature of the device will also be at a minimum, thereby reducing the leakage power that is lost. Of course, if one (or both) of the cores is running at an average of more than 50% power usage, then it is not possible to avoid any overlap, but it is still possible to minimise the times of overlap by making sure that the less used core has its active periods, so far as possible while the more used core is not in its active periods, as shown in FIG. 2 (b). Nevertheless, the active periods of the two cores should be staggered so that they do not power up or power down at the same time, as this uses more power than during steady active time and can produce interference. Similar reductions in power consumption and operating temperature may, of course, be obtained in case the multicore processor has three or more cores.

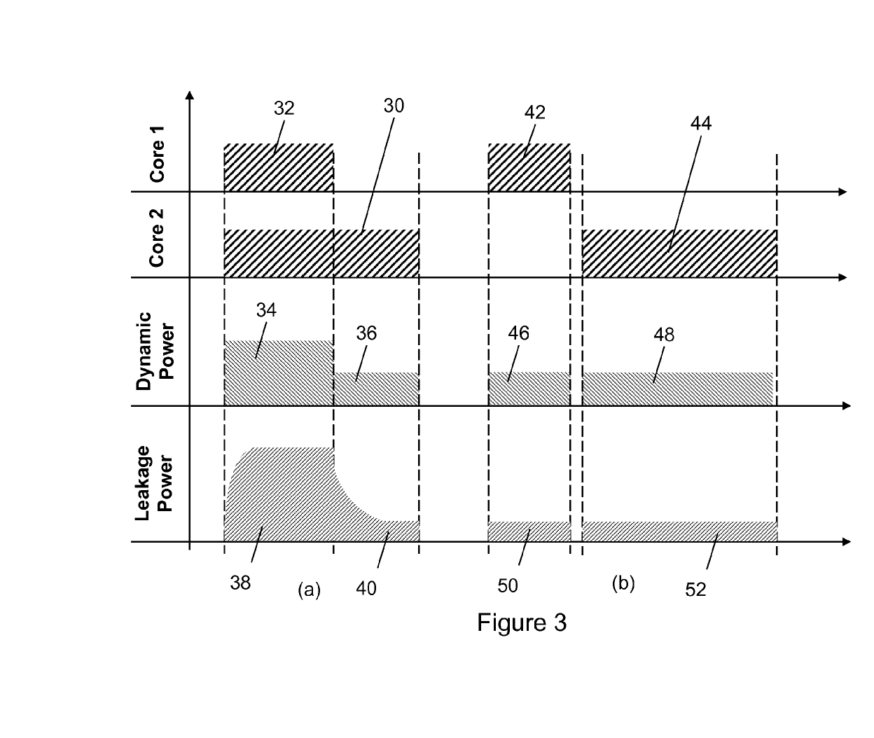

FIG. 3 shows schematically active periods of two cores without the balancing power gating technique on the left hand side (FIG. 3(a)), and with the balancing power gating technique on the right hand side (FIG. 3(b)). The leakage and dynamic power usage is also shown for both. As can be seen in FIG. 3 (a), Core 2 is active for a time 30 that is approximately twice as long as the time 32 that Core 1 is active. However, without the balancing power gating technique, the active time 32 of Core 2 completely overlaps the active time 30 of Core 1. Thus, the dynamic power utilisation during the time 34 while both cores are active is twice what it is during the time 36 when only Core 2 is active. However, the leakage power rises exponentially during the time 38 when the two cores are both active to a level that is substantially more than twice the leakage power when only one core is active, due to the fact that the temperature of the device rises more when both cores are active, which rise in temperature itself causes an increase in leakage power. Furthermore, even during the time 40 that Core 1 stops being active, the leakage power only decreases exponentially. On the other hand, if the balancing power gating technique described above is used, then the active period 42 of Core 1 is arranged not to overlap (so far as is possible) with the active period 44 of Core 2, as shown in FIG. 3(b). Thus, the dynamic power utilisation during the time 46 while Core 1 is active is at the same level as that used during the time 48 that Core 2 is active (although, of course, it is used for twice as long for Core 2). Nevertheless, because the active periods of the two cores are non-overlapping, the leakage power during the time 50 that Core 1 is active is at the same level as the leakage power during the time 52 that Core 2 is active and the overall leakage power is thus minimised because the temperature of the device is kept to a minimum. The active periods of the cores are therefore managed in a mutually dependent fashion in order to minimise the temperature and the leakage power of the device overall.

In the foregoing specification, the invention has been described with reference to a specific example of an embodiment of the invention. It will, however, be evident that various modifications and changes may be made therein without departing from the broader spirit and scope of the invention as set forth in the appended claims.

The connections as discussed herein may be any type of connection suitable to transfer signals from or to the respective nodes, units or devices, for example via intermediate devices. Accordingly, unless implied or stated otherwise, the connections may for example be direct connections or indirect connections. The connections may be illustrated or described in reference to being a single connection, a plurality of connections, unidirectional connections, or bidirectional connections. However, different embodiments may vary the implementation of the connections. For example, separate unidirectional connections may be used rather than bidirectional connections and vice versa. Also, plurality of connections may be replaced with a single connections that transfers multiple signals serially or in a time multiplexed manner. Likewise, single connection carrying multiple signals may be separated out into various different connections carrying subsets of these signals. Therefore, many options exist for transferring signals.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures can be implemented which achieve the same functionality. For example, although in the above described embodiment, the processor is described with two cores, it will be apparent that any number of cores could be present on the processor, for example, three, four, or more.

Any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps than those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements The mere fact that certain measures are recited in mutually different claims does not indicate that a combination of these measures cannot be used to advantage.

1. A multi-core processor, comprising:
a plurality of processing cores;
a plurality of power gating elements, each of said power gating elements being coupled between a respective processing core and a source of power for that core;
a plurality of individual power gating controllers, each of said individual power gating controllers being coupled to a respective power gating element for individually controlling the respective power gating element to selectively provide full power to the respective processing core only during an active period of the respective processing core; and
a common power gating controller coupled to the plurality of individual power gating controllers for controlling the individual power gating controllers to balance the active periods of the plurality of cores.

2. A multi-core processor according to claim 1, wherein the power gating elements are State Retention Power Gating, SRPG, elements.

3. A multi-core processor according to claim 1, wherein the common power gating controller controls the plurality of individual power gating controllers to balance the active periods of the plurality of cores to reduce or minimise any overlapping active periods.

4. A multi-core processor according to claim 1, wherein the common power gating controller comprises a plurality of inputs coupled to the plurality of individual power gating controllers for receiving indications from the plurality of individual power gating controllers regarding the active periods of the respective cores.

5. A multi-core processor according to claim 1, wherein the common power gating controller comprises one or more inputs for receiving indications of the different programs running on each core and for balancing the active periods of the plurality of cores based on a predetermined knowledge of the likely required active periods for the different programs.

6. A multi-core processor according to claim 1, wherein the common power gating controller comprises a memory for saving historical data regarding the active periods required for different programs running on the cores.

7. A method of power management of a multi-core processor having a plurality of processing cores, a plurality of power gating elements, each power gating element being coupled between a respective one of the cores and a source of power for that core, the method comprising controlling the respective power gating elements to selectively provide full power to the respective core only during an active period of the respective core to balance the active periods of the plurality of cores so as to substantially reduce or minimise the total power provided to all the cores.

8. A method of power management according to claim 7, wherein the respective power gating elements are controlled so as to balance the active periods of the plurality of cores to reduce or minimise any overlapping active periods.

9. A method of power management according to claim 7, wherein the respective power gating elements are controlled based on indications of different programs running on each core so as to balance the active periods of the plurality of cores based on a predetermined knowledge of the likely required active periods for the different programs.

10. A method of power management according to claim 9, further comprising saving historical data regarding the active periods required for the different programs running on the cores.
